(19) United States
(12) Patent Application Publication
(10) Pub. No.: US 2008/0107473 A1
(43) Pub. Date: May 8, 2008

(54) Disposable applicator for shining the surface of an object

(76) Inventor: Robert Deleonardis, New York, NY (US)

Correspondence Address: ANDERSON, KILL & OLICK, P.C., 1251 AVENUE OF THE AMERICAS, NEW YORK,, NY, 10020-1182, US

(21) Appl. No.: 11/546,840

(22) Filed: Oct. 12, 2006

(51) Int. Cl. B43K 8/00; A46B 5/02

(52) U.S. Cl. 401/196; 401/8

(57) ABSTRACT

A disposable liquid applicator for shining the surface of an object by dispensing a composition of liquid polish on the surface of an object to be shined comprising a porous material in the form of a sponge having a predetermined geometry and thickness and being characterized by possessing a substantial void volume, a predetermined quantity of a liquid polishing composition absorbed in said porous material to provide a single application of liquid polish, a backing layer disposed adjacent to the porous material on one side thereof with the backing layer composed of a liquid impervious material, an outer later adjacent the backing layer and a finger strap affixed to opposite transverse ends of the outer layer to permit the applicator to be easily handled whereby upon manually depressing the applicator said liquid polish retained in said porous material is dispensed from the applicator.

### FIELD OF THE INVENTION

The present invention is directed to a disposable applicator for shining the surface of an object by dispensing a composition of liquid polish on the surface of the object such as a shoe.

### BACKGROUND OF THE INVENTION

A need exists for an inexpensive applicator which will dispense a composition of a liquid polish to provide a quick shine to the surface of an object such as a shoe without the need for buffing and which does not require clean-up after application. Such an applicator would be particularly useful to a person in need of an instant shine such as a traveler or for use at an office, work site or distant location relative to one's home provided it is convenient to use, disposable after application and does not require clean up after usage. There are many solidified polishing compounds and/or waxes commercially available to shine the surface of an object. However, these products first require applying the solidified polish to the surface and then require a secondary buffing operation to achieve a shine. For example, the application of a solidified compound or soft wax requires both a polishing and buffing operation to achieve a shine and is typically a messy operation which not only involves clean up after use but also requires the user to wear appropriate apparel or risk staining one's clothing. Moreover, the secondary buffing operation is time consuming even if additional clean up can be avoided. In contrast, a liquid polish can deliver an instant shine without any buffing and requires little or no clean up after application. In addition a liquid polish is more convenient to use when time is of the essence. For purposes of the present invention any commercially available polishing composition which is liquid at ambient temperature and capable of shining an object is suitable for use as the absorbent liquid polish in the applicator of the present invention to provide a shine without buffing and any composition which is not liquid at ambient temperature is not suitable for the applicator of the present invention.

Commercially available containers of liquid polish are supply containers possessing a substantial volume of liquid polishing composition for multiple use applications. The liquid polish may be dispensed onto the surface of the object to be shined through a dispensing head which is independent of the storage container. More typically the liquid polish is dispensed from the supply container onto a soft material such as a cloth or paper and reapplied by the user to the object to be shined. There are no commercially available applicators designed to dispense liquid polish for single dosage applications and none are available for both dispensing the liquid polish and wiping off excess liquid residue.

A polishing “wipe” is commercially available for allegedly “shining” shoes composed of a tissue like material of cloth or paper. This product does not dispense liquid polish and produces a so-called “shine” by surface cleaning and not by the application of a liquid polish. For such a “wipe” to be able to truly shine an object it would be necessary for the wipe to be packaged to dispense an adequate quantity of liquid polish for shining a pair of shoes. Such a product is not commercially known or available. Moreover, each “wipe” would have to be self contained in a package storing an adequate supply of liquid polish and preferably in a hermetically sealed package to prevent the liquid polish from drying out before application. The placement of such a “wipe” in a sealed container having sufficient liquid polish when opened to provide a shine would be relatively messy and require clean-up. Accordingly, such a product would not only be expensive it would not be very useful.

### SUMMARY OF THE INVENTION

The liquid applicator of the present invention comprises a layer of porous material in the form of a sponge in a predetermined geometry and thickness characterized by possessing a substantial void volume for retaining therein a predetermined quantity of an absorbent liquid polishing composition and a backing layer of a liquid impervious material located adjacent the porous material on one side thereof for use in manually dispensing the liquid polishing composition from the sponge upon manual depression such that liquid polish will flow from the sponge in a direction away from the backing layer. The backing layer is preferably composed of a liquid impervious plastic composition.

In an alternative embodiment of the liquid applicator of the present invention, the applicator comprises a single porous sponge composed of at least two layers of porous material arranged in tandem and a backing layer of a liquid impervious material on one side of the sponge with each layer having a different void volume capacity for liquid polish. Preferably, the layer of porous material furthest from the backing layer has the largest void volume.

In yet another embodiment of the present invention, the liquid applicator comprises a layer of porous material in the form of a sponge in a predetermined geometry and thickness characterized by possessing a substantial void volume for retaining therein a predetermined quantity of an absorbent liquid polishing composition, a backing layer of a liquid impervious material located adjacent the porous material on one side thereof and an outer layer adjacent to the liquid impervious backing layer composed of a fabric selected from the group consisting of cloth, fiber, cotton, cotton felt and foam. The outer layer is preferably composed of cotton or cotton felt. A strap may be affixed to the outer layer at opposite ends to provide a finger grip for holding the applicator. The outer layer may serve to wipe off residual polish after application.

The above identified advantages of the present inventions as well as other advantages will become apparent to one skilled in the art to which the invention pertains from the following detailed description of the preferred embodiments when read in conjunction with the accompanying drawings appended to this application.

### BRIEF DESCRIPTION OF THE DRAWINGS

FIG. 1 is an isometric view of the liquid applicator of the present invention;

FIG. 2 is a cross sectional view of the liquid applicator of FIG. 1 taken along the lines 2-2 which extends through the finger strap for manually holding the liquid applicator; and

FIG. 3 is a cross sectional view similar to FIG. 2 showing another embodiment of the invention having two porous layers.

### DETAILED DESCRIPTION OF THE PREFERRED EMBODIMENTS

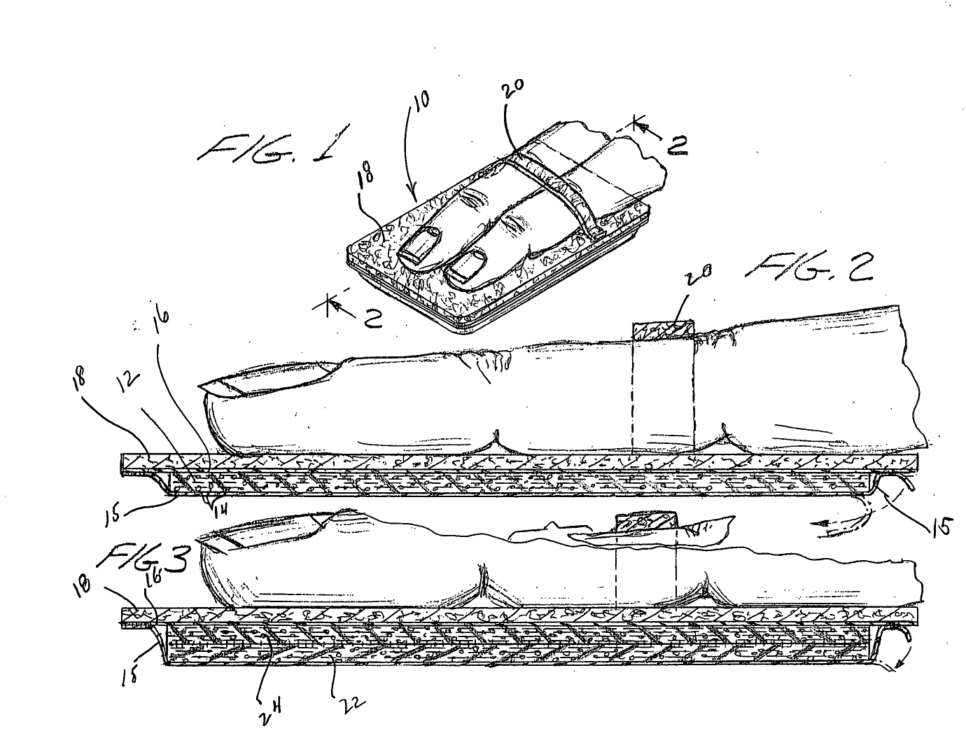

Referring to FIGS. 1 through 3 the liquid applicator 10 of the present invention is a light weight, travel-size, portable and disposable product comprising a porous absorbent material 12, preferably a sponge, which can be formed of skeletal fibers, wood shavings, rubber etc. for providing small irregular interconnected cavities or pores or a polyether or polyester foam possessing a large void volume for retaining therein a predetermined quantity of an absorbent liquid polishing composition 14. Any conventional liquid polishing composition 14 may be selected based upon the material composition of the object to be shined such as, for example, leather, plastic or metal. The liquid polishing composition should be formulated from a base of either water or an organic such as alcohol to maintain the liquidity of the polishing composition at ambient temperature. The void volume, thickness and area dimensions of the absorbent material 12 are the controlling factors for determining the amount of liquid polish which the porous material 12 will dispense. The retained amount should be designed to yield sufficient liquid polish to perform a single polishing operation on a particular object such as for shining one pair of shoes. Accordingly, the porous absorbent material 12 may be of any geometry and of any suitable thickness.

A backing layer 16 is affixed to one side of the porous absorbent material 12 using any conventional glue with the opposite side of the porous absorbent material 12 left exposed to enable the porous absorbent material 12 to make physical contact with the object to be shined. A removable bottom cover 15 may be used to cover the porous absorbent material 12 during shipment and before use of the applicator 10 to seal in the liquid polish 14. The bottom cover 15 should be thin and may be composed of a material composition similar in composition to the backing layer 16. The backing layer 16 should also be thin relative to the thickness of the porous absorbent material 12 and composed of a liquid impervious material composition preferably of plastic or rubber such that the liquid polish 14 will not leak through the layer 16 when the liquid applicator 10 is applied to the object to be shined. Although the backing layer 16 may represent the top or outer layer of the applicator 10 it is preferred to affix an outer layer 18 to the backing layer 16 as is shown in FIGS. 1-3 to form the outermost layer of the applicator 10. The outer layer 18 is intended to be held by the user when applying the applicator 10 to an object to be shined and may be composed of a material selected from the group consisting of cloth, fiber, fabric, terry cloth and foam. The outer layer 18 may be used to manipulate the applicator 10 and to distribute the liquid polish dispensed from the applicator 10 for giving an object a quick shine. The preferred composition of the outer layer 18 is cotton or cotton flannel. One preferred use for the outer layer 18 is to wipe off any residual polish after performing a quick shine. This is best accomplished by folding the outer layer 18 over the layers 12 and 16 after the polishing operation has been completed so that only the outer layer 18 is exposed thereby permitting the user to readily wipe off any residual polish remaining on the shined object and to quickly dispose of the applicator 10 without staining the users hands and/or clothing.

A finger strap 20 may be affixed to the opposite transverse ends of the layer 18 to permit the applicator 10 to be held by the finger strap 20 or to permit the user to place one or more of the users fingers through the strap 20 to facilitate use of the applicator. The finger strap 20 may be composed of any material composition. To perform a quick shine the applicator 10 is placed upon the surface of an object to be shined and the applicator 10 is manually depressed causing the liquid polish 14 to be dispensed from the absorbent material 12 directly onto the surface of the object to be shined.

An alternative embodiment of the invention is shown in FIG. 3 in which the applicator 10 includes two layers of porous absorbent material 22 and 24 affixed to one another in tandem. The applicator 10 is otherwise constructed in a manner equivalent to FIG. 1 having a backing layer 16 affixed to one side of porous material layer 24 and an outer layer 18 affixed to the backing layer 16 with a finger strap attached to the outer layer 18. The two layers of porous absorbent material 22 and 24 have different densities and void volumes with the porous absorbent material 22 possessing a void volume capacity to retain a volume of polishing composition greater than that possessed by the porous absorbent material 24. This difference in void volume may be achieved by a difference in thickness and/or a difference in material composition. Although not shown any number of porous layers may be combined.

What is claimed is:

1. A disposable liquid applicator for shining the surface of an object by dispensing a composition of liquid polish upon the surface to be shined comprising a porous material in the form of a sponge or of a foam having a predetermined geometry and thickness and being characterized by possessing a substantial void volume containing a predetermined quantity of a liquid polishing composition absorbed within said porous material to provide a single application of liquid polish and having a backing layer adjacent to the porous material on one side thereof composed of a liquid impervious material whereby upon manually depressing the applicator said liquid polish retained in said porous material is dispensed from the applicator.

2. A disposable liquid applicator as claimed in claim 1 wherein said porous material is a sponge.

3. A disposable liquid applicator as claimed in claim 2 further comprising an outer layer attached to said backing layer with said outer layer having a thickness substantially greater than the thickness of the backing layer.

4. A disposable liquid applicator as claimed in claim 3 wherein said backing layer is composed of a plastic composition or of natural or synthetic rubber.

5. A disposable liquid applicator as claimed in claim 3 wherein said outer layer is composed of a material selected from the group consisting of cloth, fiber, fabric, terry cloth and foam with the outer layer permitting the applicator to be manually manipulated for dispensing liquid polish from the applicator and for wiping off excess residue of polish from the surface of the object being shined.

6. A disposable liquid applicator as claimed in claim 5 further comprising a finger strap affixed to opposite transverse ends of the outer layer to permit the applicator to be held by the finger strap or to permit one or more fingers of a user to be placed through the finger strap to facilitate use of the applicator.

7. A disposable liquid applicator as claimed in claim 6 wherein said outer layer is composed of cotton or cotton felt.

8. A disposable liquid applicator as claimed in claim 2 comprising at least two layers of said porous material in a tandem arrangement.

9. A disposable liquid applicator as claimed in claim 8 wherein each layer of porous material possesses a different void volume capacity for said liquid polish having a combined void volume sufficient to provide a single application of liquid polish to the surface of an object to be shined.

10. A disposable liquid applicator as claimed in claim 9 wherein the layer of porous material having the smallest void volume capacity of liquid polish is located adjacent said backing layer.
